(19) United States
(12) Patent Application Publication
(10) Pub. No.: US 2004/0119276 A1
(43) Pub. Date: Jun. 24, 2004

(54) Vehicle chassis with sandwich central platform front and rear tubular frameworks and linear dampers fixed to the frameworks

(76) Inventors: Claude Fior, Caupenne d'Armagnac (FR); Fabien Fior, Caupenne d'Armagnac (FR); Celine Fior, Caupenne d'Armagnac (FR)

Correspondence Address: LEYDIG VOIT & MAYER, LTD, 700 THIRTEENTH ST. NW, SUITE 300, WASHINGTON, DC, 20005-3960, US

(21) Appl. No.: 10/451,241

(22) PCT Filed: Dec. 20, 2001
(86) PCT No.: PCT/FR01/04098

(30) Foreign Application Priority Data
Dec. 21, 2000 (FR) 00/16787

(51) Int. Cl. B62D 21/00

(52) U.S. Cl. 280/781

(57) ABSTRACT

The invention concerns a four-wheel road vehicle chassis comprising a planar platform (1) consisting of a sandwich structure, a front tubular framework (2), a rear tubular framework (3) and four linear dampers (52, 53) fixed rigidly stationary to the frameworks (2, 3). The invention also concerns a vehicle equipped with such a chassis, which can in particular be a heavy quadricycle.

The invention concerns a chassis for four-wheel self-propelled road vehicle comprising a platform formed of a sandwich structure having several plates spaced away from each other, one above the other. The invention also concerns a four-wheel self-propelled road vehicle equipped with such a chassis.

EP 0 255 749 describes a motor vehicle chassis comprising a skew sandwich structure of contorted shapes with three welded or bonded steel sheets of which one is a corrugated intermediate steel sheet containing a synthetic foam. The sandwich structure also forms the rear part of the chassis and is completed at the front by an engine mount also made of a sandwich structure. U.S. Pat. No. 2,230,448 also describes a chassis comprising a skew sandwich structure formed of riveted and welded steel sheets. These complex constructions are relatively costly and their weight/resistance ratio remains too high—in particular to produce vehicles qualifying for the so-called heavy quadricycle category.

The invention therefore sets out to remedy these disadvantages.

More particularly, the invention puts forward a chassis with which it is possible to obtain a self-propelled road vehicle having a tare (excluding storage battery for electric vehicles) of less than 550 kg and a load surface area (excluding driver cabin) of more than 3 m² for a gross weight of less than 1 500 kg. The invention particularly sets out to propose a vehicle of this type that is electrically propelled and which, on this surface area, is able to carry an effective weight (excluding driver) of up to 600 kg.

The invention also proposes a chassis with which it is possible to obtain this type of vehicle having a speed of up to 60 km/h and an engine power of less than 15 kW—in particular in the order of 6 kW.

The invention particularly brings the possibility of manufacturing such a vehicle in the form of a pickup truck with closed, glassed, cab-over-engine, fitted with items of comfort (heating, padded seats . . . ) and safety equipment (safety belt, handles . . . ) similar to those of a conventional saloon car or commercial vehicle.

The invention also concerns a chassis that is polyvalent with which, using basic common parts, it is possible to produce numerous different models of vehicles requiring minimum modifications or adaptations and at low cost.

The invention also proposes such a chassis and such a vehicle with low manufacturing costs.

The invention particularly sets out to enable such a vehicle to be produced able to receive approval for rating in the so-called heavy quadricycle category.

For this purpose, the invention concerns a chassis for a four-wheel self-propelled road vehicle comprising a sandwich structure containing several plates fixed away from each another, one above the other, characterized in that the sandwich structure forms a planar platform and in that it comprises:

a front rigid tubular framework, rigidly fixed to the front of the platform and extending forwards relative to the platform,

a rear rigid tubular framework rigidly fixed to the rear of the platform and extending backwards relative to the platform,

on either side of each framework a linear damper fixed rigidly stationary to the framework for the suspension of each of the vehicle's four wheels.

The combination of the characteristics of a chassis of the invention proves in practice to provide hitherto unequalled performance, considered impossible to reach in terms of resistance and rigidity for a very low weight despite relatively large length and width and with lowered manufacturing costs. The total weight of the chassis of the invention for a length of 3 850 mm, width of 1 450 mm including the cabin framework and four dampers (braking systems, hubs and bearings included) may be 160 kg. The planar platform imparts great rigidity to the assembly and is extremely simple and low cost to design and manufacture. The same applies to the tubular frameworks which may be mechanically welded assemblies, to the linear dampers which are light, low cost and perform well, and to the assembly of the entire chassis.

Advantageously, and according to the invention, the platform comprises an upper plate and a lower plate extending one above the other and connected via crossbars inserted between them. These plates must be rigid against tensile and compression forces perpendicular to their thickness. They may be more or less flexible. Their assembly with the cross bars must make it possible to produce a rigid platform having mechanical, rigidity and resistance characteristics adapted to its use. The plates are advantageously metallic—in particular formed of thin steel sheets. As a variant the plates may be made in synthetic material, as may be the cross bars and entire sandwich structure. The upper plate undergoes compression stresses whereas the lower plate is subject to tensile stresses. The cross bars form a rigid lattice-work making the two metal plates integral with one another and rigidifying the assembly.

Advantageously and according to the invention, the cross bars are formed of strips arranged on edge between the two metal plates. The strips are fixed rigidly between themselves and to the upper and lower plates.

Advantageously and according to the invention, the cross bars are formed of strips in light metal alloy—aluminium in particular.

Advantageously and according to the invention the plates and cross bars of the platform are assembled together rigidly by riveting and/or bonding. Also, advantageously and according to the invention each framework is fixed rigidly to the platform by riveting and/or bonding.

Also advantageously and according to the invention, each framework is essentially formed of metal tubes—in steel in particular—welded and/or bolted together. Their cross section may be circular or in any other shape (square, rectangular, . . . ).

In addition, advantageously and according to the invention the platform is fixed to the lower part of the frameworks so as to form a median drop-level plate. Advantageously and according to the invention, lateral connection parts are also provided extending at least between the upper part of the frame of each framework and the platform.

Also advantageously and according to the invention, the body of each damper is fixed rigidly stationary—in particular via bolting—to a rigid tube of a framework. This rigid fixation prevents any movement of the body of the damper (forming a recessed type connection with no degree of freedom) so that one single linear damper is sufficient to bear the chassis and superstructure of the vehicle and to carry and guide the wheel relative to the chassis, with the exception of one possibility for directional pivoting about the axis of the damper. Therefore, advantageously and according to the invention, each damper comprises a mobile rod at the lower end of which a stub axle is rigidly fixed to carry a wheel hub. Each wheel is only carried by the stub axle. Each wheel is therefore suspended from the chassis solely by a linear damper.

Advantageously and according to the invention the four dampers are identical. Advantageously and according to the invention the dampers are oleopneumatic dampers whose stiffness can be adjusted according to their air pressure and whose damping can be adjusted according to the volume and/or properties of the oil they contain.

In practice, with the chassis of the invention it is possible, with low development and manufacturing costs (in the order of 1/10 of those for saloon cars) to produce self-propelled road vehicles having a low tare (less than 550 kg excluding battery) , a large load surface area (over 3 m² excluding the driver cabin), able to carry heavy loads (up to 600 kg) which may be certified in the so-called heavy quadricycle category.

The invention also concerns a self-propelled road vehicle characterized in that it comprises a chassis of the invention.

Advantageously and according to the invention, the front framework defines a cabin, the vehicle being of pickup truck type with cab-over-engine. Advantageously and according to the invention the platform and rear framework define an effective loading surface having an area of more than 3 m² and the chassis is adapted to take a load whose weight may reach up to 800 kg.

Advantageously and according to the invention the vehicle is an electric vehicle, that is to say it comprises an electric motor driving the wheels and storage battery. Advantageously and according to the invention, it also comprises a heat engine coupled to an electric current generator able to charge the storage battery and/or supply the electric motor. Advantageously and according to the invention it has a tare of less than 550 kg so that it may be classified in the heavy quadricycle category.

A vehicle of the invention may therefore be an electric vehicle belonging to the heavy quadricycle category, having a gross weight of less than 1 500 kg, able to carry an effective load of 600 kg (excluding the driver) with a loading area of over 3 m² and a load surface size in the order of 2.4 m by 1.4 m.

The invention also concerns a chassis and a vehicle characterized by combination of all or part of the characteristics mentioned above or below.

Other purposes, characteristics and advantages will become apparent on reading the following description of a preferred embodiment of the invention given solely as an example and non-restrictive, which refers to the appended figures in which:

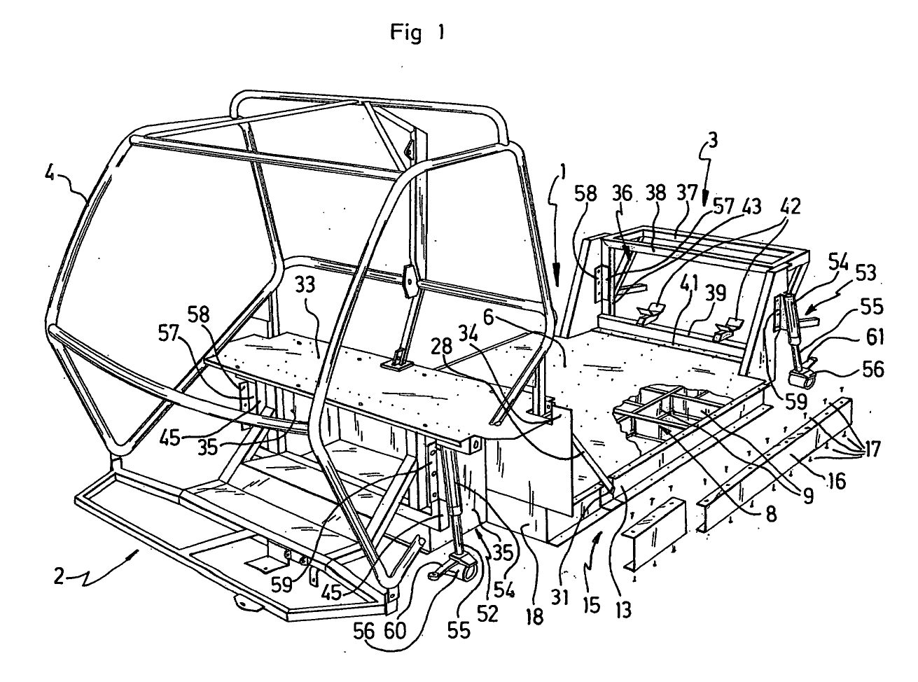

FIG. 1 is a schematic, perspective view of a chassis of the invention

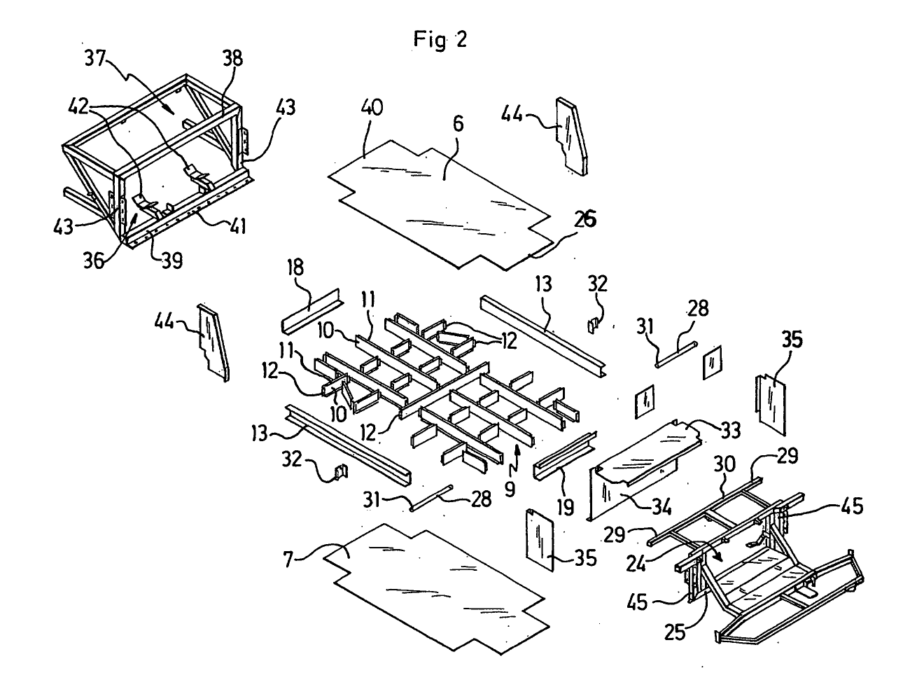

FIG. 2 is a schematic, perspective, exploded view of the platform and front and rear frameworks of a chassis of the invention,

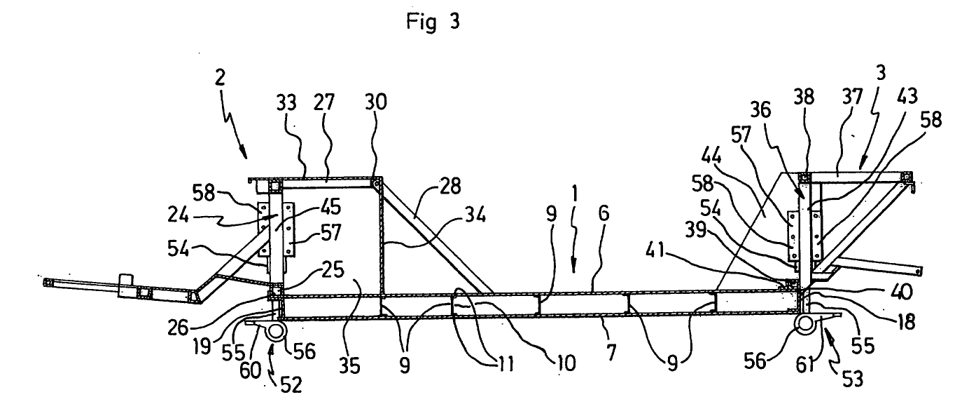

FIG. 3 is a schematic vertical, longitudinal view of a chassis of the invention,

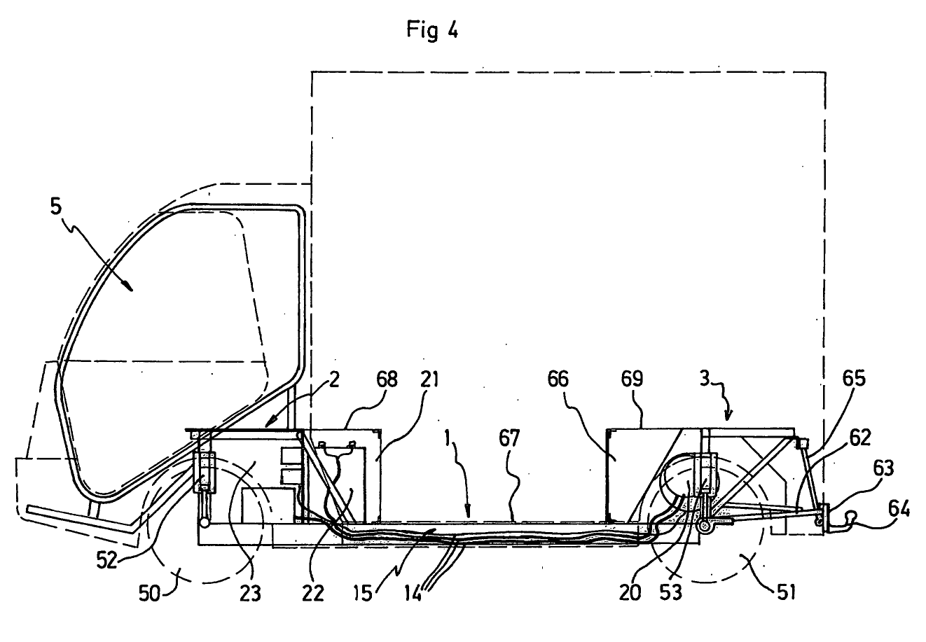

FIG. 4 is a schematic, profile view illustrating an example of vehicle according to the invention which may be obtained using the chassis in FIG. 1.

The chassis of the invention shown in FIG. 1 comprises a planar platform 1 formed of a sandwich structure, a front rigid tubular framework 2 rigidly fixed to the front of platform 1 and extending forwards relative to platform 1, and a rear rigid tubular framework 3 rigidly fixed to the back of platform 1 and extending backwards relative to platform 1. Frameworks 2, 3 are tubular in that they essentially formed of tubes which, in the example shown, are metal tubes with a circular or square cross section but may incorporate other elements such as rigidifying plates, truss rods, cables, bars or reinforcement stays . . . . The tube section may be other than square or circular. The tubes may, at least in part, be nonmetallic, in rigid synthetic material such as a carbon fibre composite.

Front framework 2 is adapted to form and/or bear a cabin floor and comprises a superstructure 4 also rigid tubular to which the bodywork parts defining cabin 5 are fixed.

Planar platform 1 is formed of a planar upper plate 6, a planar lower plate 7 whose size and shape are at least substantially similar to those of upper plate 6, these two plates 6, 7 being arranged so as to extend one above the other being connected via a rigid lattice-work 8 of cross bars 9 arranged between them.

Plates 6, 7 are preferably in metal, formed in particular of steel sheets, the thickness of the upper metal plate 6 which undergoes bending/compression stresses being greater than the thickness of lower plate 7 which undergoes bending/tensile stresses. Advantageously and according to the invention, the thickness of upper plate 6 is in the order of 2.5 mm whereas that of lower metal plate 7 is in the order of 2 mm.

Cross bars 9 are formed of strips of light rigid material—in light metal alloy in particular such as aluminium arranged—on edge between the two plates 6, 7. These cross bar strips 9 have one main planar wall 10 perpendicular to the two plates 6, 7, and wings 11 folded back relative to main wall 10 so as to extend parallel to plates 6, 7 forming the edges of cross bar strips 9 in contact with plates 6, 7 and enabling the fixation of each of cross bar strips 9 firstly to upper plate 6 and secondly to lower plate 7 so that the two plates 6, 7 are fixed via cross bars 9. Cross bar strips 9 also have wings perpendicular to main wall 10 and plates 6, 7 forming their free edges extending between the two metal plates 6, 7 enabling fixation of the different cross bar strips 9 to one another and rigidifying the assembly. Preferably and according to the invention, wings 11, 12 all extend perpendicularly on only one side of main wall 10. So that cross bar strips 9 have a cross section (vertical or horizontal) in general U-shape. As a variant, cross bar strips 9 could have an I-shaped or Z-shaped cross section, i.e. with wings 11, 12 extending partly on one side and partly on the other. Nonetheless since cross bar strips 9 are formed by folding, it is more economical to fold peripheral wings 11, 12 on the same side of main wall 10. Lattice-work 8 formed by cross bar strips 9 comprises strips 9 arranged longitudinally and strips 9 arranged crosswise (relative to vehicle motion). Some strips 9 are also arranged at an angle as shown in FIG. 2. Other lattice shapes and orientations are possible. The number of cross bar strips 9, and their arrangement, are determined in relation to the characteristics of global rigidity it is finally desired to obtain in respect of planar platform 1. Preferably, cross bar strips 9 are at least substantially uniformly distributed over the entire surface of metal plates 6, 7 and therefore over planar platform 1. In places requiring reinforcement, the density of cross bar strips 9 is increased (placed closer to each other).

Advantageously and according to the invention, said plates 6, 7 and cross bars 9 of platform 1 are rigidly assembled together by riveting and/or bonding. Preferably the assembly is made by riveting and bonding to impart very extensive structural rigidity to the assembly.

Platform 1 is completed on its sides by side members extending at least substantially along the entire length of planar platform 1.

Advantageously and according to the invention platform 1 has the general form of a rectangular deck (whose longitudinal ends are nonetheless shortened to provide wheel openings) and comprises at least one lateral longitudinal housing 15 adapted to allow passage of conduits and cables 14 extending between the front and rear of platform 1, that is to say between the two frameworks 2, 3 front and rear. Preferably, a housing 15 is provided either side of platform 1. Nonetheless as a variant not shown, one single housing 15 could be provided on only one side. Advantageously and according to the invention each longitudinal lateral housing 15 is formed of a side member 13 of platform 1 and a closing member 16 of complementary shape to that of side member 13 so that it caps side member 13 of platform 1, this closing member 16 being fixed removable fashion to side member 13, via bolts 17 for example, to provide access to longitudinal lateral housing 15 so formed between members 13, 16. Closing member 16, like side member 13, preferably has a section in general U-shape, the openings of the sections of both members 13, 16 being opposite one another and aligned together to form housing 15. Longitudinal lateral housing 15 is used to group together and protect the various conduits and cables 14 and to facilitate subsequent maintenance of the vehicle.

Planar platform 1 is closed at the rear by a rear angle bar 18—in metal in particular—which connects plates 6, 7, and at the front by an angle bar 19—in metal in particular—which also connects plates 6, 7.

Each of frameworks 2, 3 is formed of metal tubes—in steel in particular—welded and/or bolted together, i.e. it is a mechanically welded structure. The shape given to each framework 2, 3 depends upon the desired characteristics of the vehicle and the functions to be performed by frameworks 2, 3. In the example shown FIG. 4, rear framework 3 serves as mount for engine 20 of the vehicle which is an electric motor for example. Rear framework 3 is also used to fix a certain number of rear bodywork parts (rear bodywork panel, wheel openings or mudguard . . . ). Similarly in the example shown in FIG. 4, front framework 2 serves as cabin chassis and defines a first front boot 21 immediately at the front of platform 1, intended for example to house storage battery 22, and a second front boot 23 housing all the vehicle's electric or electronic devices and accessories. Boots 21, 23 are formed not only by framework 2, but also by thin walls in metal or synthetic material as appropriate.

Each framework 2, 3 is rigidly fixed to platform 1 by riveting and/or bonding, preferably riveted and bonded. Advantageously and according to the invention, platform 1 is fixed to the lower part of frameworks 2, 3 so as to form a drop-level median plate for the vehicle of the invention.

Front framework 2 comprises a vertical rectangular frame 24 comprising a lower horizontal cross tube 25 rigidly fixed along the front cross edge 26 of upper plate 6 of platform 1. Tube 25 preferably has a square cross section Also front angle bar 19 connecting the two plates 6, 7 also covers the front of front horizontal cross tube 25, at least in part, and the assembly is riveted and bonded. The upper part of front rectangular frame 24 is extended backwards by an upper horizontal frame 27. Two inclined lateral truss rods 28 connect the side ends of rear tube 30 of frame 27 to platform 1 on either side. Preferably, the lower rear ends of truss rods 28 are fixed to fixation parts 32 themselves rigidly fixed to lattice-work 8, i.e. to one of cross bar strips 9 and/or to side member 13 of platform 1. Truss rods 28 in particular prevent tipping of framework 2 forwards and downwards relative to platform 1. Also, an angled wall 33 in metal or synthetic material is fixed to the upper horizontal frame 27 of front framework 2 so that a horizontal portion thereof covers frame 27 and a vertical portion 34 thereof extends downwards as far as platform 1 from the rear tube of frame 27.

Two side walls 35 are fixed on either side to the front of the horizontal portion of wall 33, to the rear of vertical frame 24 and below horizontal frame 27. Preferably, these side walls 35 extend vertically from horizontal frame 27 as far as lower plate 7 of platform 1. Walls 33, 35 are riveted—preferably riveted and bonded—both together and to the tubes of front framework 2. The caisson so formed at the front of platform 1 with framework 2 can not only be used as a storage compartment (second front boot 23) but also rigidities fixation of front framework 2 to platform 1 in extremely economical, light and effective manner.

Rear framework 3 also comprises a vertical rectangular frame 36 extended backwards by an upper horizontal frame 37 extending from upper tube 38 of vertical frame 36. Vertical rectangular frame 36 comprises a lower horizontal cross tube 39, of square cross section, fixed to the free rear cross edge 40 of upper plate 6 of platform 1 via an angle bar 41, the whole being riveted and/or bonded, preferably riveted and bonded. This lower horizontal cross tube 39 also carries mount 42 of vehicle engine 20. The vertical frame 36 comprises two lateral uprights 43 connecting lower tube 39 to upper tube 38. Two side plates 44 are riveted and/or bonded, preferably riveted and bonded, along lateral uprights 43 and to upper 6 and lower 7 plates of platform 1. These lateral plates 44 therefore connect vertical frame 36 to platform 1 rigidifying the assembly of rear framework 3 to platform 1, in the same manner as truss rods 28 rigidify the assembly of front framework 2 to platform 1.

Rear framework 3 also comprises other tubes and parts enabling fixation of various vehicle accessories and components (bodywork parts, tow bar, . . . ).

Therefore in a chassis of the invention, each of the two frameworks 2, 3 comprises a rectangular tubular frame 24, 36 comprising a lower horizontal cross tube 25, respectively 39, rigidly fixed along a cross edge 26, respectively 40, of platform 1 and more precisely of upper plate 6 of platform 1. Truss rods 28 and lateral plates 44 form lateral connecting parts extending between at least the upper part of corresponding frame 24, 36 of each framework 2, .3 and platform 1.

The vehicle of the invention is a four-wheel vehicle, namely two front wheels 50 and two back wheels 51. Each wheel 50, 51 is suspended from the chassis of the invention by means of a damper 52, 53. Therefore the chassis of the invention comprises on each side of framework 2, 3 a linear damper 52, 53 having a body 54 fixed rigidly stationary to corresponding framework 2, 3 for suspending each of the vehicle's four wheels 50, 51. Two front dampers 52 are fixed to each side of front framework 2, and two rear dampers 53 are fixed to each side of rear framework 3. The dampers are linear dampers, i.e. they comprise a mobile part 55 with translation movement relative to body 54, wheels 50, 51 being mounted integral with mobile part 55. Therefore dampers 52, 53 define a predetermined rectilinear linear pathway for wheels 50, 51 which they carry without the need to provide other wheel guiding means relative to the chassis as in a conventional chassis (triangles, articulated struts, . . . ). Wheels 50, 51 of a vehicle of the invention are therefore suspended solely by linear dampers which simultaneously act as flexible return systems, shock absorbers and translation guides for each of wheels 50, 51. Advantageously and according to the invention, dampers 52, 53 are oleopneumatic dampers whose stiffness can be adjusted by their air pressure and whose damping can be adjusted according to the volume and/or properties of the oil they contain. This type of damper can fulfil the above-mentioned functions while being of minimum weight. At the lower end of mobile rod 55 a stub axle 56 is rigidly fixed adapted to house and carry a hub for wheel 50, 51. Rear wheels 51, in the example shown in FIG. 4, are driving wheels coupled by appropriate transmission to engine/motor 20 via stub axles 56. It is to be noted that each of wheels 50, 51 is solely carried by stub axle 56 itself integral with mobile rod 55 of corresponding damper 52, 53.

Body 54 of each damper 52, 53 is rigidly fixed to one of rigid tubes of corresponding framework 2, 3, by bolting for example. Advantageously and according to the invention, front dampers 52 are fixed by bolting to vertical side tubes 45 (uprights) of the vertical rectangular frame 24 of framework 2. For this purpose an inner mount 57 in the form of a double angle bar is positioned on the inside to tube 45 and rigidly fixed to this tube 45 by riveting or bonding for example and has two coplanar vertical side wings 58 adapted to house wings 59 of conjugate shape of body 54 of each damper 52. Wings 58, 59 can therefore be bolted to one another, tube 45 being embedded between mount 57 and body 54. Similarly, each rear damper 53 is fixed to vertical side uprights 43 of vertical frame 36 of rear framework 3 via an inner mount 57, the wings 59 of body 54 of rear dampers 53 being bolted to wings 58 of this mount 57, embedding upright 43. In addition, side plates 44 are inserted between wings 58 of mount 57 and wings 59 of body 54. Each inner mount 57 may be formed of a single part which overlaps corresponding tube 45, 43 or on the contrary it may be two separate angle bars respectively fixed to each side of tube 43, 45 as in the example shown. The four linear dampers 52, 53 of the chassis of the invention are advantageously identical. Stub axles 56 carrying front wheels 50 comprise an extension 60 adapted for connection of steering, so that front wheels 50 are guide wheels. Indeed mobile rod 55 is able to pivot about the axis of movement defined by body 54 of damper 52. On the other hand, at the rear, stub axle 56 is locked in rotation relative to rear framework 3 so that the rear wheels 51 are not guide wheels. For this purpose, stub axles 56 of rear wheels 53 also have an extension 61 which can be connected to framework 3 or to any other fixed part of the chassis, for example a tie rod of tow bar device 62 whose front end is connected to stub axle 56 and whose rear end is articulated with a plate 63 fitted with hooking means 64, this plate 63 being suspended from rear framework 3 via an articulated bar 65. As a variant, extension 61 of stub axle 56 of rear wheel 51 may be connected to rear framework 3 via a simple articulated connecting rod allowing movement of stub axle 56 with rod 55 of the damper but maintaining this stub axle 56 in a fixed direction relative to the longitudinal direction of the vehicle.

The chassis of the invention is extremely light but nevertheless offers considerable rigidity and considerable resistance. It is extremely simple and low cost to design and manufacture. In particular it is to be noted that the sandwich structure forming platform 1 being planar, its design (choice of materials, thickness, number of cross bars 9 . . . ) and manufacture are largely facilitated. Similarly tubular frameworks 2, 3 are easy to design and manufacture according to the stresses to which they are to be submitted.

In the example shown in FIG. 4, the vehicle of the invention is a pickup truck with cab-over-engine, front framework 2 defining a cabin 5. This cabin 5 may be fitted with all technical items for comfort and necessary accessories for driving the vehicle and transporting one or more passengers in cabin 5 (seats, steering wheel, pedals, floor, heating, glass windscreen, . . . ). Platform 1 and rear framework 3 define an effective loading area behind cabin 5 which can be given a great number of variants of embodiment depending upon the applications of use of the vehicle of the invention. In the example shown batteries 22 are enclosed in front boot 21, and a rear boot 66 completes and covers the front of framework 3 which houses the electric motor 20 coupled to rear wheels 3. Between the two boots 21, 66, platform 1 defines a median drop-level plate 67. Each boot 21, 66 also has an upper free surface 68, respectively 69, able to take loads. The effective loading area is therefore the sum of surfaces 68, 69 of boots 21, 66 plus that of median plate 67. This effective loading area may be greater than 3 m³ and can take loads of up to 800 kg. The loading volume can exceed 4 m² with a closed van and can be much greater than this value if no rear superstructure.

A superstructure can be fixed to platform 1 and/or framework 3, side racks for example, or a tarpaulin superstructure, bodywork walls to form a van . . . .

Similarly the vehicle of the invention may be used to transport passengers, with seats possibly being arranged on the free upper surfaces 68, 69 of front boot 21 and rear boot 66, passengers resting their feet on drop-level median plate 67.

Example:

A vehicle of the invention as shown in FIG. 4 was produced with the following dimensions:

overall length 3 850 mm

overall width 1 450 mm

The size of platform 1 was: 1 800 mm×1 450 mm.

The total weight of the chassis of the invention shown in FIG. 3 (metal platform 1, metal front and rear frameworks 2, 3, dampers 52, 53, braking systems, hubs and bearings included) was 160 kg.

The vehicle is equipped with a 6 kW electric motor. A heat engine coupled to an electric current generator may also be provided in rear boot 66 to charge the storage battery and/or supply the electric motor 20. The tare of the vehicle with no rear superstructure and excluding storage battery, heat engine and current generator is less than 550 kg so that it can be classified in the heavy quadricycle category. It has an effective loading area of over 3 m² (2.4 m×1.4 m) and a loading volume with no height limitation which may be typically be 4 m³ for a van model. It can carry a load of 600 kg at a speed of up to 60 km/h. It is to be noted that these performance results are obtained when cabin 5 is fitted with all traditional items of comfort for motor vehicles, namely padded seats, glass windscreen, heating unit, air vents, complete bodywork including articulated side doors, . . . .

This type of heavy quadricycle may even be used to transport 4 to 6 passengers if the effective loading area is equipped with seating.

The invention may be the subject of numerous applications and variants of embodiment relative to the described, shown examples. In particular, the linear dampers may be designed differently (with outer and/or inner spring in particular), the vehicle of the invention may be equipped with a heat engine in which case it will not come under the category of heavy quadricyles, different extra equipment may possibly be provided, the vehicle may not necessarily have a cab over engine but a middle cabin, platform 1 being used to take the driver and passenger of a main cabin, . . . .

1. Chassis of a four-wheel self-propelled road vehicle (50, 51) comprising a sandwich structure containing several plates fixed distant from each other, one above the other, characterized in that the sandwich structure forms a planar platform (1) and in that it comprises:
a front rigid tubular framework (2) rigidly fixed to the front of platform (1) and extending forwards relative to platform (1),
a rear rigid tubular framework (3) rigidly fixed to the back of platform (1) and extending backwards relative to platform (1),
on either side of each framework (2, 3) a linear damper (52, 53) having a body (54) fixed rigidly stationary to frameworks (2, 3) for the suspension of each of the vehicle's four wheels (50, 51).

2. Chassis according to claim 1, characterized in that platform (1) comprises an upper plate (6) and a lower plate (7) extending one above the other and connected via cross bars (9) arranged between them.

3. Chassis according to claim 2, characterized in that plates (6, 7) are in metal—formed in particular of steel sheets.

4. Chassis according to either of claims 2 or 3, characterized in that the thickness of the upper plate (6) is greater than that of the lower plate (7).

5. Chassis according to any of claims 2 to 4, characterized in that the thickness of the upper plate (6) is in the order of 2.5 mm.

6. Chassis according to any of claims 2 to 5, characterized in that the thickness of the lower plate (7) is in the order of 2 mm.

7. Chassis according to any of claims 2 to 6, characterized in that the cross bars (9) are formed of strips (9)—formed in particular of light metal alloy such as aluminium—arranged on edge between the two metal plates (6, 7).

8. Chassis according to claim 7, characterized in that the strips have a main planar wall (10) perpendicular to metal plates (6, 7), and wings (11) parallel to metal plates (6, 7) forming their edge in contact with metal plates (6, 7) and enabling their fixation.

9. Chassis according to either of claims 7 or 8 characterized in that strips (9) have wings (12) perpendicular to the main wall (10) and to plates (6, 7) forming their free ends extending between the two plates (6, 7).

10. Chassis according to either of claims 8 of 9 characterized in that wings (11, 12) extend perpendicularly on only one side of main wall (10).

11. Chassis according to any of claims 7 to 10 characterized in that strips (9) are formed by bending.

12. Chassis according to any of claims 2 to 11 characterized in that cross bars (9) form a rigid lattice work.

13. Chassis according to any of claims 2 to 12 characterized in that plates (6, 7) and cross bars (9) of platform (1) are assembled together rigid fashion by riveting and/or bonding.

14. Chassis according to any of claims 1 to 13 characterized in that platform (1) comprises at least one lateral longitudinal housing (15) adapted to allow passage of conduits and cables (14) extending between the front and rear of platform (1).

15. Chassis according to claim 14, characterized in that lateral longitudinal housing (15) comprises a side member (13) of platform (1) and a closing member (16) which caps side member (13) of platform (1) and is fixed in removable manner to side member (13) to allow access to lateral longitudinal housing (15).

16. Chassis according to any of claims 1 to 15 characterized in that each framework (2, 3) is essentially formed of steel tubes welded and/or bolted together.

17. Chassis according to any of claims 1 to 16 characterised in that each framework (2, 3) is fixed rigidly to platform (1) by riveting and/or bonding.

18. Chassis according to any of claims 1 to 17, characterized in that platform (1) is fixed to the lower part of frameworks (2, 3) so as to form a median drop-level plateau (67).

19. Chassis according to any of claims 1 to 18 characterized in that each framework (2, 3) comprises a rectangular frame (24, 36) comprising a lower horizontal cross tube (25, 39) fixed rigidly along a cross end edge (26, 40) of platform (1).

20. Chassis according to claim 19 characterized by side connection parts (28, 44) extending at least between the upper part of frame (24, 36) of each framework (2, 3) of platform (1).

21. Chassis according to any of claims 1 to 20 characterized in that the body (54) of each damper (52, 53) is rigidly fixed to a rigid tube (45, 43) of a framework (2, 3).

22. Chassis according to any of claims 1 to 21 characterized in that the body (54) of each damper (52, 53) is fixed by bolting.

23. Chassis according to any of claims 1 to 22 characterized in that the four linear dampers (52, 53) are identical.

24. Chassis according to any of claims 1 to 23 characterized in that the dampers (52, 53) are oleopneumatic dampers whose stiffness can be adjusted according to their pressure and whose damping can be adjusted according to the volume and/or properties of the oil they contain.

25. Chassis according to any of claims 1 to 24 characterized in that each damper (52, 53) comprises a mobile rod (55) at the lower end of which a stub axle (56) is fixed adapted to carry the hub of a wheel (50, 51).

26. Self-propelled road vehicle characterized in that it comprises a chassis according to any of claims 1 to 25.

27. Vehicle according to claim 26 characterized in that the front framework (2) defines a cabin (5) the vehicle being of pickup truck type with cab over engine.

28. Vehicle according to either of claims 26 or 27 characterized in that platform (1) and rear framework (3) define an effective loading area of more than 3 m², and the chassis is adapted to take an effective load with a weight of up to 600 kg.

29. Vehicle according to any of claims 26 to 28, characterized in that it comprises an electric motor (20) driving the wheels and a storage battery (22).

30. Vehicle according to claim 29 characterized in that it comprises a heat engine coupled to an electric current generator able to charge storage battery (22) and/or to supply the electric motor (20).

31. Vehicle according to any of claims 26 to 30 characterized in that it has a tare of less than 550 kg so that it can be classified in the heavy quadricycle vehicle category.
